(19) United States
(12) Patent Application Publication
(10) Pub. No.: US 2010/0125484 A1
(43) Pub. Date: May 20, 2010

(54) REVIEW SUMMARIES FOR THE MOST RELEVANT FEATURES

(75) Inventors: YANQING CHEN, BELLEVUE, WA (US); IMRAN AZIZ, SEATTLE, WA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/271,087

(22) Filed: Nov. 14, 2008

(51) Int. Cl. G06Q 10/00; G06Q 30/00

(52) U.S. Cl. 705/10

(57) ABSTRACT

A method, system, and medium are provided for capsule summaries of reviews, such as product and service reviews. Raw comments and reviews are collected from several sources, which can be obtained from different locations, such as Internet sites. A number of features for each product or service category are developed, which are then correlated to the collected comments and reviews. A rating is assigned to each comment and review, which indicates the level of positivity or negativity of the comment or review. Ratings for each feature are combined to give an overall rating of the product or service under review. More relevant results, such as the most positive and the most negative reviews of each feature, along with the overall rating, are returned to a user to provide a quick summary of the selected product or service. If a user would like more details or more results, options are provided to go deeper into the capsule summary to obtain as much information or detail as desired.

### BACKGROUND

A vast amount of information that describes various products and services on the market is available. This information could be in the form of objective documentary information or an advertisement which provides biased information. The available information could also be in the form of professional and user reviews. Collecting and analyzing this vast and varied amount of information, in order to make an educated marketing decision can be overwhelming.

### SUMMARY

Embodiments of the invention are defined by the claims below. A high-level overview of various embodiments of the invention is provided to introduce a summary of the systems, methods, and media that are further described in the detailed description section below. This summary is neither intended to identify key features or essential features of the claimed subject matter, nor is it intended to be used as an aid in isolation to determine the scope of the claimed subject matter.

Embodiments of the invention include a method and system for providing capsule summaries of reviews, such as product reviews and service reviews. Raw comments and reviews are collected from several sources. These sources can be obtained from different locations, such as Internet sites. Product categories and service categories are utilized to group similar items together. A number of features for each product category or service category are developed. The features are correlated to the collected comments and reviews. A rating that indicates the level of positivity or negativity of the comment or review is assigned to each comment and review.

Ratings for each feature are combined to give an overall rating of the product or service under review. More relevant results, such as the most positive and the most negative reviews of each feature, along with the overall rating, are returned to a user to provide a quick summary of the selected product or service. If a user would like more details or more results, options are provided to search the capsule summary to obtain as much information or detail as desired. Links to purchase the reviewed product or service are also available to a user.

In one embodiment, the comments and reviews comprise a historical account of the selected product or service. In another embodiment, the comments and reviews comprise maintenance and repair information of the selected product under review. In still another embodiment, the comments and reviews comprise a price comparison of the total items for the particular product or service under review.

### BRIEF DESCRIPTION OF THE SEVERAL VIEWS OF THE DRAWINGS

Illustrative embodiments of the invention are described in detail below, with reference to the attached drawing figures, which are incorporated by reference herein, and wherein:

FIG. 1 depicts a general computing system used in accordance with embodiments of the invention;

FIG. 2 is a flow chart which depicts the method and system used for embodiments of the invention;

FIG. 3 depicts a user computing display for selecting options used for embodiments of the invention;

FIG. 4 is a schematic of a marketing review computing system used in accordance with embodiments of the invention; and

FIG. 5 is a schematic of a database used in accordance with embodiments of the invention.

### DETAILED DESCRIPTION

Embodiments of the invention provide systems and methods for review summaries and their most relevant features. This detailed description satisfies the applicable statutory requirements. Although the terms “step,” “block,” “module,” etc. might be used herein to connote different components of methods or systems employed, the terms should not be interpreted as implying any particular order among or between various steps herein disclosed unless and except when the order of individual steps is explicitly described.

Throughout the description of different embodiments of the invention, several acronyms and shorthand notations are used to aid the understanding of certain concepts pertaining to the associated system and methods. These acronyms and shorthand notations are intended to help provide an easy methodology of communicating the ideas expressed herein and are not meant to limit the scope of any embodiment of the invention.

As one skilled in the art will appreciate, embodiments of the invention may be embodied as, among other things: a method, system, graphical user interface (GUI), or computer-program product that is embodied on one or more tangible computer-readable media. Accordingly, the embodiments may take the form of a hardware embodiment, a software embodiment, or an embodiment combining software and hardware. In one embodiment, the invention takes the form of a computer-program product that includes computer-useable instructions embodied on one or more computer-readable media. Computer-readable media include both volatile and nonvolatile media as well as removable and non-removable media.

By way of example, and not limitation, computer-readable media comprise computer-storage media and communication media. Computer-storage media, or machine-readable media, include media implemented in any method or technology for storing information. Examples of stored information include computer-useable instructions, data structures, program modules, and other data representations. Computer-storage media include, but are not limited to, random access memory (RAM), read-only memory (ROM), electrically erasable programmable read-only memory (EEPROM), flash memory used independently from or in conjunction with different storage media, such as, for example, compact-disc read-only memory (CD-ROM), digital versatile discs (DVD), holographic media or other optical disc storage, magnetic cassettes, magnetic tape, magnetic disk storage, or other magnetic storage devices. These memory components can store data momentarily, temporarily, or permanently. The computer readable media include cooperating or interconnected computer readable media, which exist exclusively on a processing system or distributed among multiple interconnected processing systems that may be local to or remote from the processing system. Communication media can embody computer-readable instructions, data structures, program modules or other data in a modulated data signal, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. Combinations of any of the above should also be included within the scope of computer-readable media.

One embodiment of the invention may be described in the general context of computer code or machine-useable instructions, including computer-executable instructions such as program modules, being executed by a computer or other machine. Generally, program modules including routines, programs, objects, components, data structures, and the like refer to code that perform particular tasks or implement particular abstract data types. Embodiments described herein may be practiced in a variety of system configurations, including handheld devices, consumer electronics, general-purpose computers, more specialty computing devices, etc. Embodiments described herein may also be practiced in distributed computing environments where tasks are performed by remote-processing devices that are linked through a communications network.

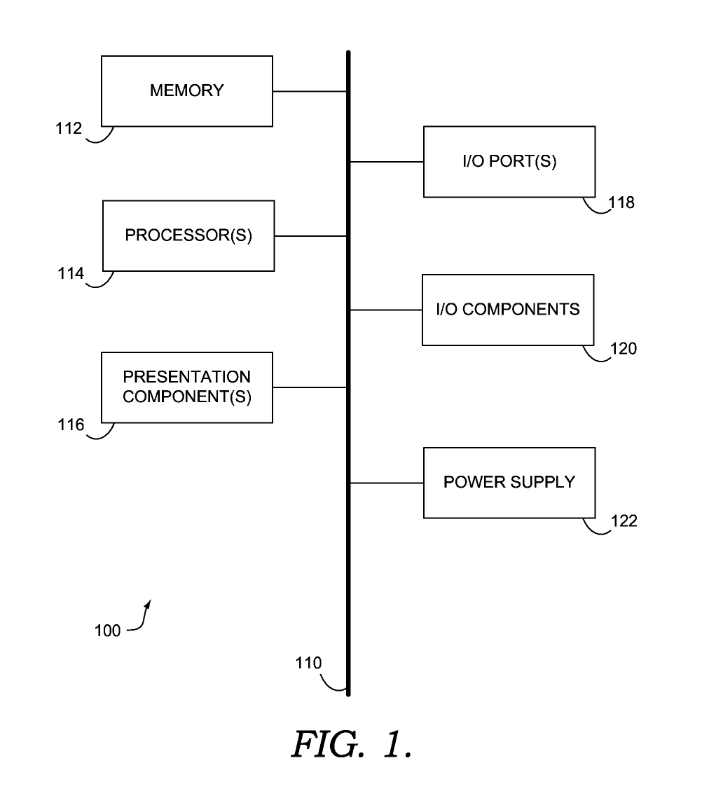

Having briefly described a general overview of the embodiments described herein, an exemplary computing device is described below. Referring initially to FIG. 1 in particular, an exemplary operating environment for implementing an embodiment of the invention is shown and designated generally as computing device 100. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In one embodiment, computing device 100 is a conventional computer (e.g., a personal computer or laptop).

With continued reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component 116 such as a display device to be an I/O component. Also, processors 114 have memory 112. It will be understood by those skilled in the art that such is the nature of the art, and, as previously mentioned, the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1, and are referenced as “computing device.”

Computing device 100 can include a variety of computer-readable media. By way of example, and not limitation, computer-readable media may comprise RAM; ROM; EEPROM; flash memory or other memory technologies; CDROM, DVD or other optical or holographic media; magnetic cassettes, magnetic tape, magnetic disk storage or other magnetic storage devices, or similar tangible media that are configurable to store data and/or instructions relevant to the embodiments described herein.

Memory 112 includes computer-storage media in the form of volatile and/or nonvolatile memory. The memory may be removable, non-removable, or a combination thereof. Exemplary hardware devices include solid-state memory, hard drives, cache, optical-disc drives, etc. Computing device 100 includes one or more processors 114 that read data from various entities such as memory 112 or I/O components 120. Presentation component(s) 116 present data indications to a user or other device. Exemplary presentation components 116 include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

The components described above in relation to computing device 100 may also be included in a wireless device. A wireless device, as described herein, refers to any type of wireless phone, handheld device, personal digital assistant (PDA), BlackBerry®, smartphone, digital camera, or other mobile devices (aside from a laptop) capable of communicating wirelessly. One skilled in the art will appreciate that wireless devices will also include a processor and computer-storage media to perform various functions. Embodiments described herein mention to both a computing device and a wireless device. In embodiments, computing devices can also refer to devices that are running applications of which images are captured by the camera in a wireless device.

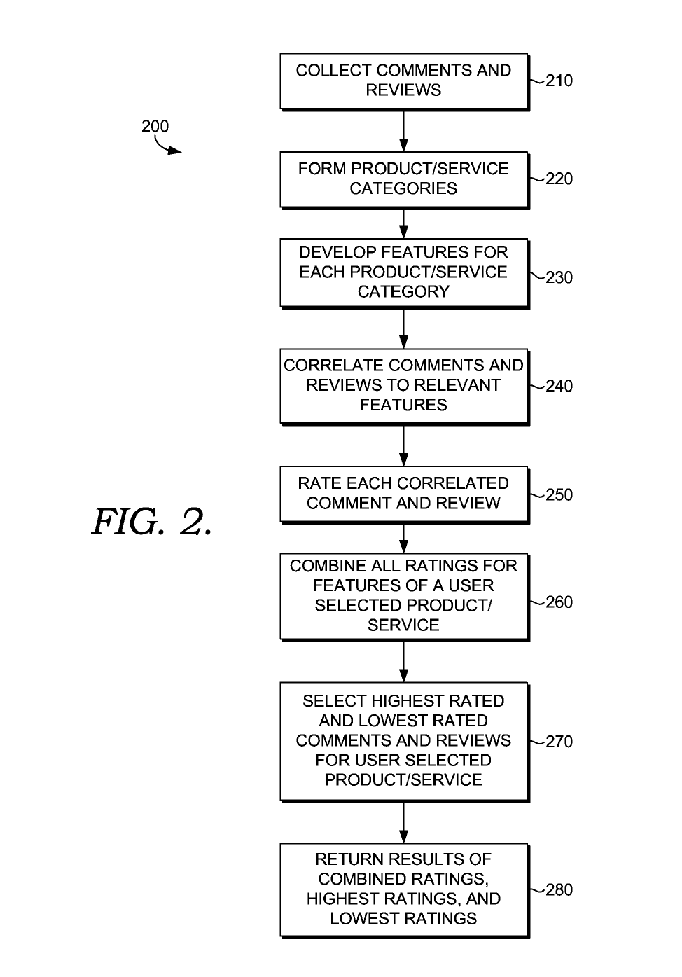

The computing system described above is configured to provide capsule summaries of reviews, such as product and service reviews, as described below. FIG. 2 is a flow chart which depicts the method used for capsule summary reviews, shown as capsule summary review flow chart 200. A vast array of comments and reviews, primarily from users of a product or service, is collected in step 210. As used herein, the term “comment” is a short description, usually one or two sentences, that provides a limited description of one or more features of a product or service. Also, the term “review” is a more detailed and thorough description, and will usually describe more features of a product or service.

Comments and reviews can originate from several sources, most of which are obtained by means of a search engine via an interconnected computing network. The Internet is one example of such a network, but other examples include local networks and intranets. Sources could also originate from any number of journals and magazines, blogs, or personal and social organizations. The comments and reviews can be stored in a database of a computing system, such as the system described above with reference to FIG. 1. The database may include a search index to aid in searching. The search index, as well as the comments and reviews, are usually updated periodically. One mechanism for collecting the large volume of comments and reviews is by means of crawling Internet sites. The listed sources, networks, and mechanisms are given as illustrations only, and embodiments of the invention should not be construed to be limited to such sources, networks, or mechanisms.

Comments and reviews can also encompass many areas of focus. For instance, a focus may be the cost of a product or service, and how the cost varies within the spectrum of that particular product or service. Related comments and reviews of the cost focus may include issues such as customer service, availability of the product or service, and technical assistance. Another focus may be maintenance and repair of a particular product, and how this varies within the spectrum for that particular product. The overall cost of a product can be influenced by its maintenance and repair record. Also, the focus of comments and reviews may be a historical account of a product or service. Examples of historical accounts that can change with time may include price, maintenance and repair, available accessories, availability of compatible software, compatibility with other like products, and usefulness in light of newer products on the market.

When the collection of comments and reviews for products and services is being processed or is completed, categories are formed in step 220. Product categories could include, but are not limited to, items such as phones, televisions, home appliances, and tools, to name just a few. Service categories could include, but are not limited to, areas such as medicine, law, accounting, and entertainment, to name just a few.

Each product and service category has certain features associated with it, and these features are developed in step 230. The features are the individual items that are reviewed for each product or service. Features could be determined from product and service websites or advertisements, professional reviews, user reviews, or a frequency of occurrence within the collected comments and reviews. As one example, home appliance features might include durability, cost, noise, level of maintenance, and available colors. Many more features of both products and services are included within the scope of the invention, and the invention is therefore not limited to such features. Some features can be present for more than one category.

The comments and reviews that were collected in step 210 are now correlated to their relevant features in step 240. Each feature of each product and service is now correlated with any number of related comments and reviews. These correlated comments and reviews are individually rated on a uniform scale, as shown in step 250. An embodiment of rated comments and reviews comprises a numerical designation, where a one might be the highest rating, such as excellent, and a five might be the lowest rating, such as very poor.

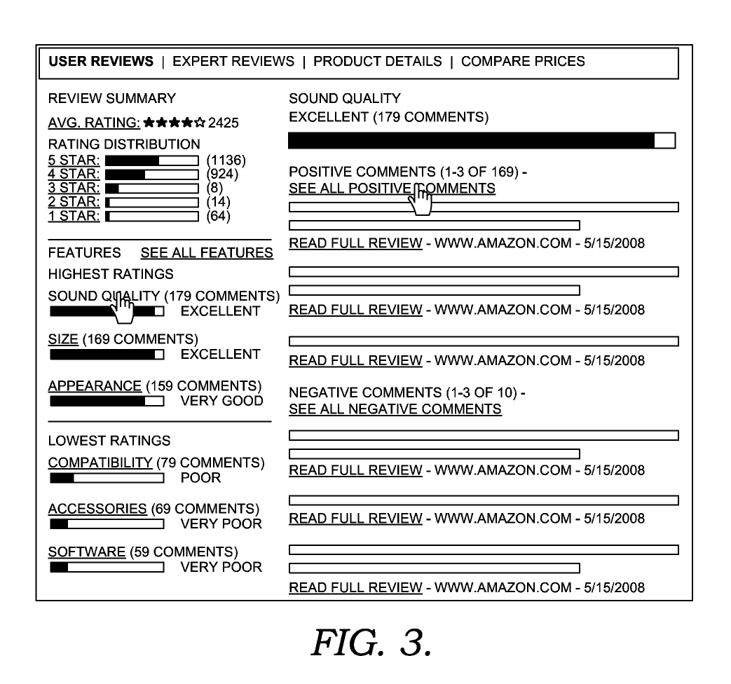

All of the ratings for selected features of a product or service are combined in step 260. The more relevant features of a product or service are summarized in a capsule summary review, such as that shown in FIG. 3. As shown by this example, this particular product received a total of 2425 reviews. The distribution of ratings ranged from 1136 reviews at the overall highest 5 star rating, and 64 reviews at the overall lowest 1 star rating. The capsule review summary also rates and summarizes individual features for the selected product or service. As shown in the FIG. 3 example, the “sound quality” feature received the most excellent reviews (169 out of 179 comments were positive), and the “software” feature received the most very poor reviews (approximately 50 out of 59 comments were negative). An option is also available to view the ratings of all of the features for the selected product or service. An alternative embodiment allows a user to make a custom list of features that are important. This custom list can be saved for later use, and it can also be altered at a later time as needed.

Referring back to FIG. 2, embodiments of the invention select a certain number of highest rated reviews and lowest rated reviews for a particular feature of the product or service in step 270. As shown in the example of FIG. 3, links are provided to the three most positive comments and the three most negative comments for the “sound quality” feature. A link is also provided to the source of the comment or review. An option is also provided for the user to view all of the positive comments or all of the negative comments. Even though the “sound quality” feature is exhibited in FIG. 3, any other features can be displayed with these same options available.

Each feature of the selected product or service provides many links to the comments and reviews, and to the sources of those comments and reviews. This provides many opportunities for a sponsoring body to embed advertising links within any of the reviews or source sites. An opportunity to purchase any of the reviewed products or services could be provided, with a partial reimbursement made to the host of the embedded advertising link.

The capsule review summary provides a quick display of the best and worst reviews, and the combined overall ratings of a particular product or service in step 280 of FIG. 2. Embodiments of the invention allow a user to receive a condensed informative view of a particular product or service in a short period of time. After viewing a number of capsule review summaries, a user can elect to obtain more information of a few select products or services from their respective capsule review summaries. This enables a user to make a more educated decision in a shorter period of time.

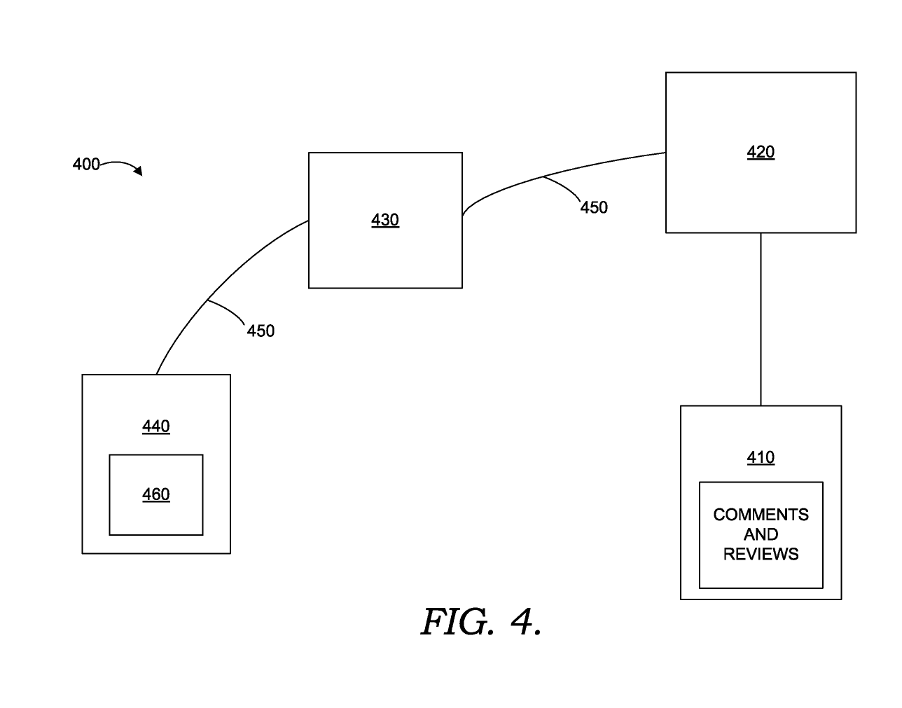

FIG. 4 is a schematic of a marketing review computing system 400, which was utilized to perform the steps of the capsule summary review flow chart 200, described above with reference to FIG. 2. The collected comments and reviews can be stored in a database, such as database 410. As previously described, the comments and reviews originate from a number of sources. These sources can be part of an information network 420, such as the world wide web (www). However, sources can also originate from several other bodies or entities, such as but not limited to, journals and magazines, blogs, or personal and social organizations. Specific sources can be found through the use of a search engine 430, with results of a specific search returned to a client 440, via an interconnected computing network 450. A summary review 460 is returned to the client 440, with specific results including the combined review ratings, the highest review ratings, and the lowest review ratings of the product or service, as described above with reference to FIG. 3.

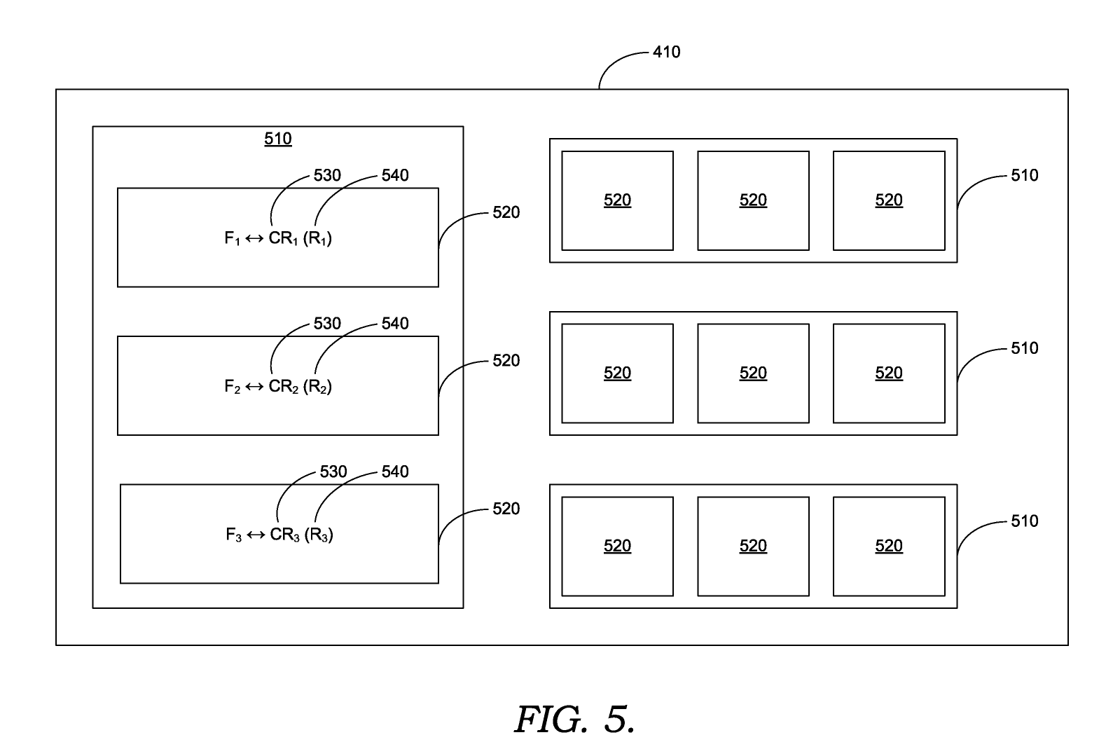

FIG. 5 is a more detailed schematic of the database 410, which contains the collected comments and reviews. As previously described above, a number of marketing categories 510 are formed from the collected comments and reviews. Depending upon the search results of comments and reviews, these categories will usually be a collection of product or service categories. For each marketing category 510, a number of features 520 are developed. Features 520 can be developed from product and service websites or advertisements, professional reviews, user reviews, or determined from a frequency of occurrence within the collected comments and reviews. Each individual comment and review, which is denoted as CR 530 in FIG. 5, is correlated to the most appropriate feature 520. In addition, each comment and review, CR 530 is rated according to its degree of positivity or negativity. This rating is denoted as R 540 in FIG. 5. As an illustrative example in FIG. 5, a first feature, F₁ is correlated to a first comment and review, CR₁, which has a rating of R₁. A second feature, F₂ is correlated to a second comment and review, CR₂, which has a rating of R₂; and a third feature, F₃ is correlated to a third comment and review, CR₃, which has a rating of R₃. FIG. 5 illustrates three features 520 within each category 510. However, any category 510 could have any number of features 520 contained within it, and multiple categories 510 could have varying numbers of features 520 within the same database 410.

Many different arrangements of the various components depicted, as well as embodiments not shown, are possible without departing from the spirit and scope of the invention. Embodiments of the invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A method of providing marketing reviews, comprising:
collecting comments and reviews of a plurality of products or services from a plurality of sources;
categorizing said plurality of products or services into a plurality of product or service categories;
developing a plurality of features for each of said plurality of product or service categories;
correlating said comments and reviews with said plurality of features for each of said plurality of products or services;
assigning a rating value to each of said correlated comments and reviews;
selecting a range of highest assigned rating values assigned to said correlated comments and reviews;
selecting a range of lowest assigned rating values assigned to said correlated comments and reviews;
returning results of said selected highest assigned rating values and said selected lowest assigned rating values for a user selected product or service onto a displaying monitor;
returning results of combined ratings for all of said developed plurality of features for said user selected product or service onto said displaying monitor; and
providing user options for viewing said comments and reviews for one of said selected highest assigned rating values, said selected lowest assigned rating values, and said combined ratings for said user selected product or service.

2. The method of claim 1, wherein said collecting comprises crawling said plurality of sources via an interconnected computing network.

3. The method of claim 1, wherein said comments and reviews comprise user comments and reviews.

4. The method of claim 1, wherein said plurality of features are determined according to a frequency of occurrence of said features within said comments and reviews.

5. The method of claim 1, wherein said providing user options further comprises constructing a custom list from said plurality of features.

6. The method of claim 1, wherein said comments and reviews comprise a historical account of said user selected product or service.

7. The method of claim 1, wherein said comments and reviews comprise maintenance and repair information of said user selected product or service.

8. The method of claim 1, wherein said comments and reviews comprise a price comparison of said user selected product or service.

9. The method of claim 1, further comprising providing embedded advertising links during said viewing of said comments and reviews.

10. The method of claim 1, further comprising providing a reference to a source from said plurality of sources which corresponds to a user selected option from said comments and reviews.

11. A marketing review computing system, comprising:
a search engine;
a plurality of computing resources;
an interconnected computing network;
a plurality of marketing categories;
a plurality of features for each of said plurality of marketing categories;
a plurality of comments and reviews correlated to said plurality of features for each of a plurality of products or services;
a database, said database containing said plurality of comments and reviews;
a rating value assigned to each of said correlated comments and reviews; and
a summary review of correlated comments and reviews according to one of a range of highest assigned rating values, a range of lowest assigned rating values, and a combined rating for all of said determined plurality of features for a user selected product or service from said plurality of products or services.

12. The system of claim 11, wherein said database comprises a search index.

13. The system of claim 12, wherein said comments and reviews and said search index are updated periodically.

14. The system of claim 11, wherein said comments and reviews comprise a historical account of said user selected product or service.

15. The system of claim 11, wherein said comments and reviews comprise maintenance and repair information of said user selected product.

16. The system of claim 11, wherein said comments and reviews comprise a price comparison of said user selected product or service.

17. The system of claim 11, further comprising embedded advertising links located within said comments and reviews.

18. A computer readable medium that provides instructions for providing marketing reviews, which, when executed cause the performance of operations, comprising:
collecting comments and reviews of a plurality of products or services from a plurality of sources;
categorizing said plurality of products or services into a plurality of product or service categories;
developing a plurality of features for each of said plurality of product or service categories;
correlating said comments and reviews with said plurality of features for each of said plurality of products or services;
assigning a rating value to each of said correlated comments and reviews;
selecting a range of highest assigned rating values assigned to said correlated comments and reviews;
selecting a range of lowest assigned rating values assigned to said correlated comments and reviews;
returning results of said selected highest assigned rating values and said selected lowest assigned rating values for a user selected product or service onto a displaying monitor;
returning results of combined ratings for all of said developed plurality of features for said user selected product or service onto said displaying monitor; and
providing user options for viewing said comments and reviews for one of said selected highest assigned rating values, said selected lowest assigned rating values, and said combined ratings for said user selected product or service.

19. The computer readable medium of claim 18, further comprising providing embedded advertising links during said viewing of said comments and reviews.

20. The computer readable medium of claim 18, further comprising providing a reference to a source from said plurality of sources which corresponds to a user selected option from said comments and reviews.
